(19) United States
(12) Patent Application Publication
(10) Pub. No.: US 2015/0062114 A1
(43) Pub. Date: Mar. 5, 2015

(54) DISPLAYING TEXTUAL INFORMATION RELATED TO GEOLOCATED IMAGES

(71) Applicant: Andrew Ofstad, San Francisco, CA (US)

(72) Inventor: Andrew Ofstad, San Francisco, CA (US)

(21) Appl. No.: 13/658,794

(22) Filed: Oct. 23, 2012

(51) Int. Cl. G06T 15/00

(52) U.S. Cl. 345/419

(57) ABSTRACT

To provide information about geographic locations, an interactive 3D display of geolocated imagery is provided via a user interface of a computing device. A view of the geolocated imagery is generated from a perspective of a notational camera having a particular camera pose, where the camera pose is associated with at least position and orientation. A selection of a location within the interactive display is received via the user interface, and a symbolic location corresponding to the selected location is automatically identified, where at least textual information is available for the symbolic location. Automatically and without further input via the user interface, (i) the notational camera is moved toward the selected location, and (ii) overlaid textual description of the symbolic location that includes a link to additional information related to the symbolic location is provided.

### FIELD OF DISCLOSURE

This disclosure relates to displaying information about imagery shown on a computer display, and more specifically, to providing textual information about images presented in a map application.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Maps are visual representations of information pertaining to the geographical location of natural and man-made structures. A traditional map, such as a road map, includes roads, railroads, hills, rivers, lakes, and towns within a prescribed geographic region. Maps were customarily displayed on a plane, such as paper and the like, and are now also commonly displayed via map applications on computing devices, such as computers, tablets, and mobile phones.

Map applications and corresponding map databases are good at showing locations as a result of a search or via navigation commands received through a user interface. However, map applications are not capable of providing contextual information about locations displayed via the application.

### SUMMARY

In one embodiment, a method for providing information about geographic locations is implemented in a computing device. The method includes providing, using one or more processors, an interactive three-dimensional (3D) display of geolocated imagery for a geographic area via a user interface of the computing device, including generating a view of the geolocated imagery from a perspective of a notational camera having a particular camera pose, where the camera pose is associated with at least position and orientation. The method also includes receiving, via the user interface, a selection of a location within the interactive display and automatically identifying a symbolic location corresponding to the selected location, where at least textual information is available for the symbolic location. Further, the method includes automatically and without further input via the user interface, (i) moving the notational camera toward the selected location, and (ii) providing overlaid textual description of the symbolic location that includes a link to additional information related to the symbolic location.

In another embodiment, a method for efficiently providing information about locations displayed via a map application is implemented in a network device. The method includes receiving, from a client device via a communication network, an indication of a camera position corresponding to a photographic image being displayed on the client device via a map application, automatically determining a symbolic location corresponding to the photographic image based on the received indication of the camera position, and providing, to the client computer, a textual description of the symbolic location and search links related to the symbolic location for use at the client device to display the textual description and search links in an overlay layer of the map application.

In yet another embodiment, a computing device includes one or more processors, a computer-readable memory coupled to the one or more processors, a network interface configured to transmit and receive data via a communication network, and a user interface configured to display images and receive user input. The computer-readable memory stores instructions that, when executed by the one or more processors, causes the computing device to (i) provide an interactive display of geolocated imagery for a geographic area via the user interface, (ii) receive a selection of a location within the interactive display via the user interface, (iii) automatically identify a symbolic location corresponding to the geolocated imagery at the selected location, and (iv) automatically and without further input via the user interface, update the interactive display to organize the geolocated imagery around the subject and provide overlaid textual description of the identified subject including an interactive link to additional information.

### BRIEF DESCRIPTION OF THE DRAWINGS

FIG. 1 is a block diagram of an example computer system that implements the techniques of the present disclosure to display overlaid textual information for selected geographic locations;

FIG. 2 is a flow diagram of an example method for displaying textual information at a client device;

FIG. 3 is a flow diagram of an example method for server-side generation of textual information for use by a client device;

FIG. 4 is a screenshot showing an unexpanded overlay window in a software application; and

FIG. 5 is another screenshot showing an expanded overlay window in a software application.

### DETAILED DESCRIPTION

According to a technique for providing information about a geographic location identifiable within displayed geolocated imagery, a software module automatically identifies a symbolic location (e.g., the name or another identifier of the subject of the image) to which the user has navigated, and, using the identified symbolic location, provides overlaid textual information that may include links to additional resources. For example, the overlaid textual information may appear in a text overlay box or “omnibox” that includes a text description of the symbolic location, links to local or global (e.g., Internet) resources about the symbolic location, and a search box with pre-filled search terms for searching for still further information about the identified symbolic location. More particularly, the links may refer to landmark information, user comments, photos, etc.

In some implementations, the omnibox is generated and updated automatically as the user traverses the map to reflect the current subject of, for example, a street view for every change in user focus during the mapping session. For example, navigating to the Lincoln Memorial will cause the display of an omnibox with information about the monument and related search information. To this end, some or all images that make up the 3D scene include tags, or metadata that indicates the symbolic location and, in some cases, the position and orientation of the camera. A device that displays geolocated imagery with an overlaid omnibox may receive tags as part of metadata associated with the geolocated imagery. Subsequently, the device may use the tags locally, or the device may provide the tags to the map server for efficient retrieval of the information related to the symbolic location. In general, the images may be from any of many map application orientations including street view, helicopter view, or some satellite views.

By contrast, known map applications generally require turning on a photo-layer and explicitly clicking on a photo to display the selected image in either full screen mode or as an overlay in street view. Even in the case of linked images, no description of the subject is presented nor are any links for more information about the subject presented. Geographic-based tags, such as store names, may be presented in some map applications, but a user must explicitly click on the geographic tag to bring up an omnibox with additional information and links. Linking imagery to symbolic locations is a process involving analysis of tags, geolocation of images, 3D pose (angle and field of view), etc., to determine the subject of an image.

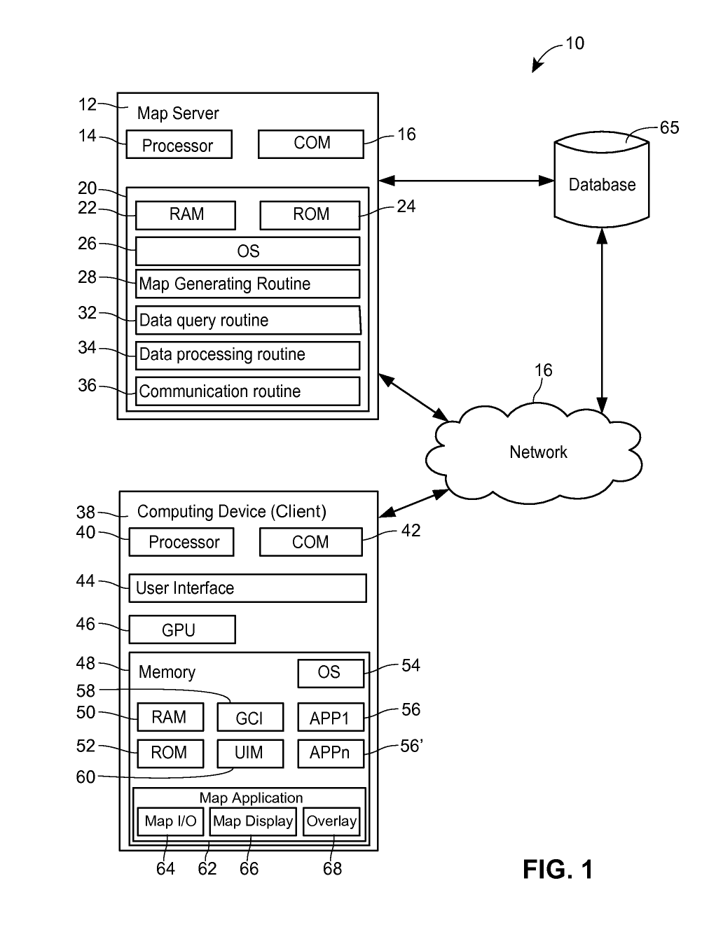

FIG. 1 illustrates an example map display system 10 capable of implementing some or all of the techniques for surfacing textual information for images in map applications, web browsing applications, and other suitable applications. The map display system 10 includes a computing device 12. The computing device 12 is shown to be a server device, e.g., a single computer, but it is to be understood that the computing device 12 may be any other type of computing device, including, and not limited to, a mainframe or a network of one or more operatively connected computers. The computing device 12 includes various modules, which may be implemented using hardware, software, or a combination of hardware and software. The modules include, in part, at least one central processing unit (CPU) or processor 14 and a communication module (COM) 16. The communication module 16 is capable of facilitating wired and/or wireless communication with the computing device 12 via any known means of communication, such as Internet, Ethernet, 3G, 4G, GSM , WiFi, Bluetooth, etc.

The computing device 12 also includes a memory 20, which may include any type of persistent and/or non-persistent memory modules capable of being incorporated with the computing device 12, including random access memory 22 (RAM), read only memory 24 (ROM), and flash memory. Stored within the memory 20 is an operating system 26 (OS) and one or more applications or modules. The operating system 26 may be any type of operating system that may be executed on the computing device 12 and capable of working in conjunction with the CPU 14 to execute the applications.

A map generating application or routine 28 is capable of generating map data for display on a screen of a client device. The map generating routine 28 is stored in the memory 20 and includes instructions in any suitable programming language or languages executable on the processor 14. Further, the map generating routine 28 may include, or cooperate with, additional routines to facilitate the generation and the display of map information. These additional routines may use location-based information associated with the geographic region to be mapped. In operation, the map generating routine 28 generates map data for a two- or three-dimensional rendering of a scene. The map data in general may include vector data, raster image data, and any other suitable type of data. As one example, the map generating routine 28 provides a set of vertices specifying a mesh as well as textures to be applied to the mesh.

A data query routine 32 may match geographic location information, such as addresses or coordinates, for example, to symbolic locations. For example, the data query routine 32 may match 1600 Pennsylvania Ave. in Washington to the White House, or the intersection of Clark and Addison in Chicago to Wrigley Field. The data query routine 32 then may use the symbolic location to search for information related to the symbolic location. To this end, the data query routine 32 may utilize database 65 that stores photographic images, text, links, search results, pre-formatted search queries, etc. More generally, the data query routine 32 may retrieve information related to a symbolic location from any suitable source located inside or outside the system 10.

With continued reference to FIG. 1, a data processing routine 34 may use pre-programmed rules or heuristics to select a subset of the information available for distribution to a client device 38 using a communication routine 36 the controls the communication module 16. The data processing routine 34 may further format the selected information for transmission to client devices along with the corresponding map data.

In one example implementation, the client computing device 38 may be a stationary or portable device that includes a processor (CPU) 40, a communication module (COM) 42, a user interface (UI) 44, and a graphic processing unit (GPU) 46. The client computing device 38 also includes a memory 48, which may include any type of physical memory capable of being incorporated with or coupled to the client computing device 38, including random access memory 50 (RAM), read only memory 52 (ROM), and flash memory. Stored within the memory 48 is an operating system (OS) 54 and at least one application 56, 56′, both of which may be executed by the processor 40. The operating system 54 may be any type of operating system capable of being executed by the client computing device 36. A graphic card interface module (GCI) 58 and a user interface module (UIM) 60 are also stored in the memory 48. The user interface 44 may include an output module, e.g., a display screen and an input module (not depicted), e.g., a light emitting diode (LED) or similar display as well as a keyboard, mouse, trackball, touch screen, microphone, etc.

The application 56 may be a web browser that controls a browser window provided by the OS 54 and displayed on the user interface 44. During operation, the web browser 56 retrieves a resource, such as a web page, from a web server (not shown) via a wide area network (e.g., the Internet). The resource may include content such as text, images, video, interactive scripts, etc. and describe the layout and visual attributes of the content using HTML or another a suitable mark-up language. In general, the application 56 is capable of facilitating display of the map and photographic images received from the map server 12 via the user interface 44.

According to another implementation, the client device 38 includes a map application 62, which may be a smart phone application, downloadable Javascript application, etc. The map application 62 can be stored in the memory 48 and may also include a map input/output (I/O) module 64, a map display module or routine 66, and an overlay module 68. The overlay module 68 of the map application 62 may be in communication with the UIM 60 of the client device 38.

The map input/output routine 64 may be coupled to the port to request map data for a location indicated via the user interface and may receive map and map-related information responsive to the request for map data. The map input/output routine may include in the request for the map data a camera location, camera angle, and map type used by a server processing the request to identify a subject of the results of the request for map data.

The map display module 66 in general may generate an interactive digital map responsive to inputs received via the user interface 60. The digital map may include a visual representation of the selected geographic area in 2D or 3D as well as additional information such as street names, building labels, etc.

For example, the map display module 66 may receive a description of a 3D scene in a mesh format from the map server 12, interpret the mesh data, and render the scene using the GPU 46. The map display module 66 also may support various interactions with the scene, such as zoom, pan, etc., and in some cases walk-through, fly-over, etc.

The overlay box routine 68 may receive, process, and display information related to the symbolic location (which is identified based on the selection of a location within the interactive 3D display of geolocated imagery). For example, when the user selects a location on the screen, the overlay box routine 68 may generate an overlaid textual description of the symbolic location in the form of an omnibox. The overlaid textual description may include a search term input box with one or multiple search terms prefilled, links to external web resources, a note describing the location or the subject of the photograph, user reviews or comments, etc. In an example implementation, the overlay box routine 68 generates the overlaid textual description automatically and without receiving further input from the user. The user may directly activate the search box to conduct an Internet search or activate the links displayed as part of the overlaid textual description, for example. Further, in addition to generating overlaid textual description, the overlay box routine 68 may automatically advance the notational camera toward the selection location.

In some implementations, the overlay box routine 68 receives the information for overlaid display at the same as the mesh, 2D vector data, or other map data corresponding to the scene. In other implementations, the overlay box routine 68 requests the additional information from the map server only when the user selects a location within the interactive display.

In an example scenario, a user at the client device 38 opens the map application 62 or access a map via a browser 56, as described above. The map application 62 presents a window with an interactive digital map of one of several map types (for example, a schematic map view, a street-level 3D perspective view, a satellite view). As a more specific example, the digital map may be presented in a street view mode using geolocated photographic imagery taken at a street level. Navigating through an area may involve the display of images viewed from the current location and may include landmarks, public buildings, natural features, etc. In accordance with the current disclosure, the map application 62 may identify the subject matter of an image presented from a current map location and may display a text box overlay window with a textual description of the subject matter and the opportunity to navigate to other information about the image.

The overlay window may be expandable so as to reduce the occlusion of the 3D scene by the window. For example, in the unexpanded mode, the overlay window may display only limited information about the symbolic location, such as the name and a brief description, for example. In the expanded mode, the overlay window may include additional information, such as links, search terms, etc. An unexpanded overlay window may be expanded in response to the user clicking on the window, activating a certain control (e.g., a button), or in any other suitable manner.

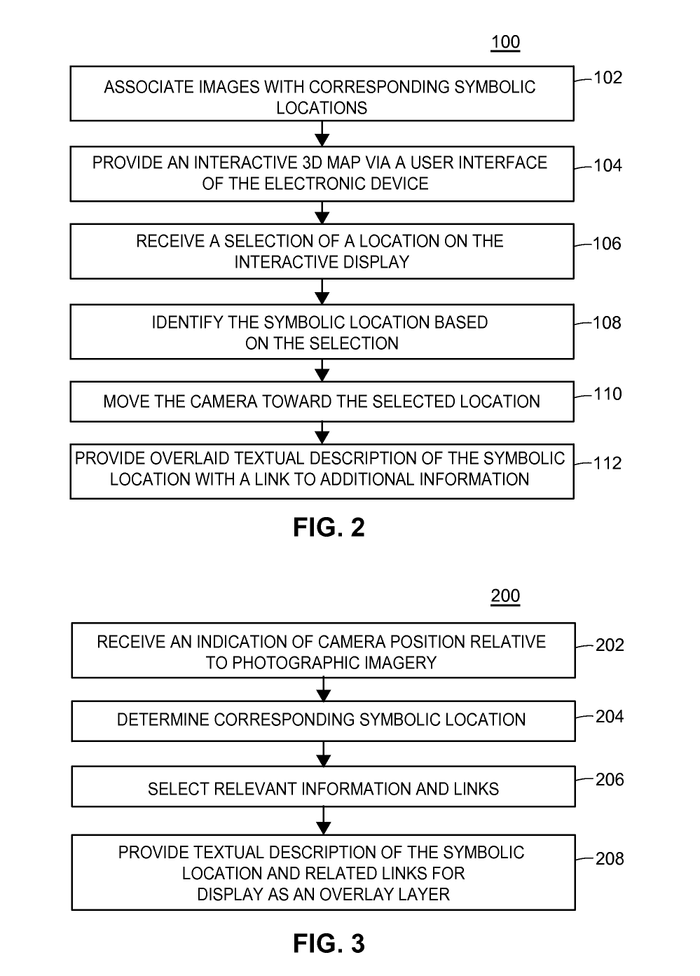

Example methods for facilitating the display of textual information associated with images displayed in a map on an electronic device, which may be implemented by the components described in FIG. 1, are discussed below with reference to FIGS. 2 and 3. As one example, the methods may be implemented as computer programs stored on a tangible, non-transitory computer-readable medium (such as one or several hard disk drives) and executable on one or several processors. Although the methods described above can be executed on individual computers, such as servers or personal computers (PCs), it is also possible to implement at least some of these methods in a distributed manner using several computers, e.g., using a cloud computing environment.

FIG. 2 illustrates a method 100 of displaying textual information for images in a map application. The method 100 may be implemented in the application 62 illustrated in FIG. 1, for example. Alternatively, the method 100 can be partially implemented in the application 62 and partially (e.g., step 102) in the routines 28-36.

At block 102, an association between at least some of the images displayed via the map application and respective symbolic locations is created. In one implementation, images available for display in an application on a client device are automatically or manually reviewed and compared to images in other repositories, including public repositories. When a match is found for a particular image, information (such as image metadata) in the other repositories may be used to identify the subject of the image. For example, tags identifying the subject may be used. Geolocation information from the current location of the map application may be matched to geolocation information in the public image databases as a further method of finding information about the subject. Once the association is created, for example, that a northeast view from Clark and Addison in Chicago is Wrigley Field, the symbolic location for Clark and Addison is established as Wrigley Field. Once established, the ability to find further information about the symbolic location is greatly enhanced. As indicated above, the symbolic locations in general may be a landmark, a business, a natural feature, etc.

At block 104, an interactive 3D map including geolocated imagery, schematic map data, labels, etc. is displayed via the user interface of an electronic device. Next, at block 106, a selection of a location within the interactive 3D map is received. The method 100 may interpret the selection to determine a location at block 108 and, at block 110, move the camera to the new location. The method 100 also may send the location information to a map server to get updated data related to the new camera location. However, in an embodiment, when extensive map and image data are available at the client device, communication with a server may not be necessary.

At block 112, a message may be received with the necessary information for moving the camera and text information for an identified symbolic location, or the information may be retrieved locally at the client device. In any case, the camera is moved to the new location and a textual description of the symbolic location is provided. For example, one or several geolocated photographic images corresponding to the symbolic location are displayed and an overlay window is generated. The overlay window may be updated automatically when navigation causes the viewport to display another symbolic location. If no related information is available for a particular location, that is, no symbolic locations are present in the viewport, the overlay window may not be displayed.

FIG. 3 is a flow diagram of an example method 200 for server-side generation of textual information for use by a client device map application. At block 202, a message is received from a client device via a communication network, indicating a camera location associated with an image displayed via the map application. The message may further specify a map type of the currently displayed information, for example, an overhead view, a street view, a 3D perspective view, etc. The message in some cases may indicate camera elevation, e.g., an altitude in an overhead view map type, and/or may include a camera frustum angle and azimuth, such as in a street view map type. Other map types will have other specific details about the camera location that leads, ultimately, to what imagery is to be displayed at the map application. In some cases, the message may include a symbolic location identifier gathered from metadata associated with the image displayed via the map application. In other embodiments, the identification of a symbolic location may be made at the server using information received in the message.

Next, using the camera location received from the client computer, the method 200 determines a symbolic location associated with the camera location (block 204). As discussed above, more than one technique for developing the symbolic location from a camera location may be available. After the symbolic location is established, an Internet search of the symbolic location may be performed at block 206 and representative text resulting from the Internet search describing the symbolic location may be selected. Further, a textual description including links and other information may be prepared using a search term associated with the symbolic location. For example, one result of the Internet search may be a rated list of popular searches associated with the symbolic location. This rated list may be used to populate the search links to be provided to the map application

The results generated at block 206 may be stored in a memory of a map server (e.g., the map server 12). The description and links may be saved for a period of time and reused in response to other requests associated with the symbolic location although the data may be generated with each new request. At block 208, this information may be provided to the client computer to be displayed in an overlay window of a software application, which may be a map application, a browser application, etc. In an embodiment, the server may send only a textual description of the symbolic location in an HTML-formatted message, for example, if vector map data for the location is already at the client computer and the information for the overlay window is the only new information required at the client computer.

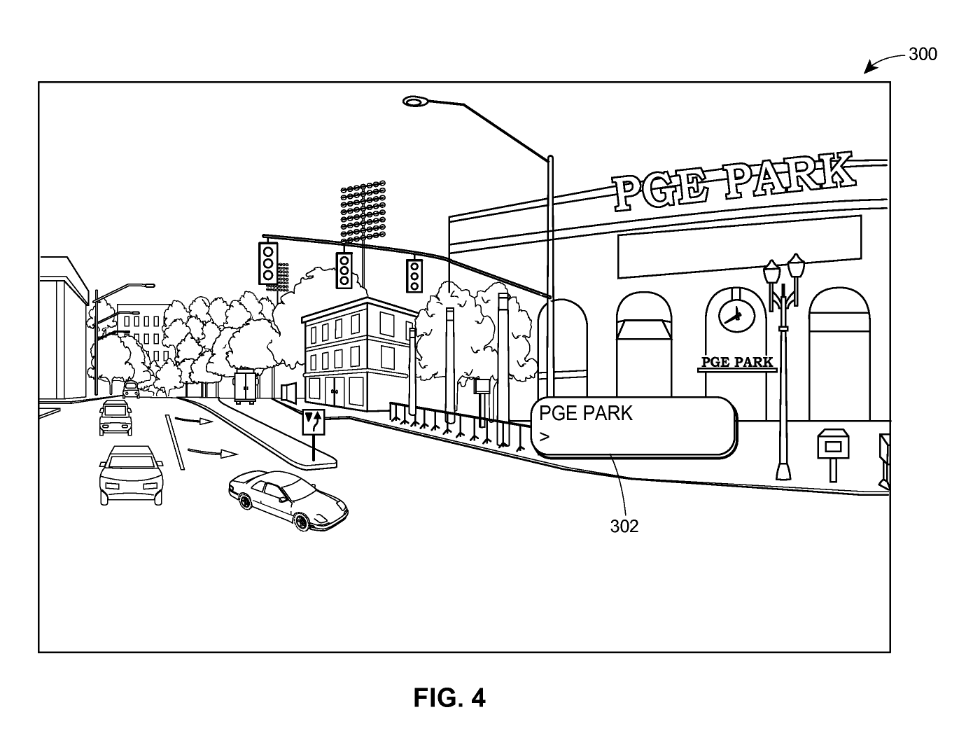

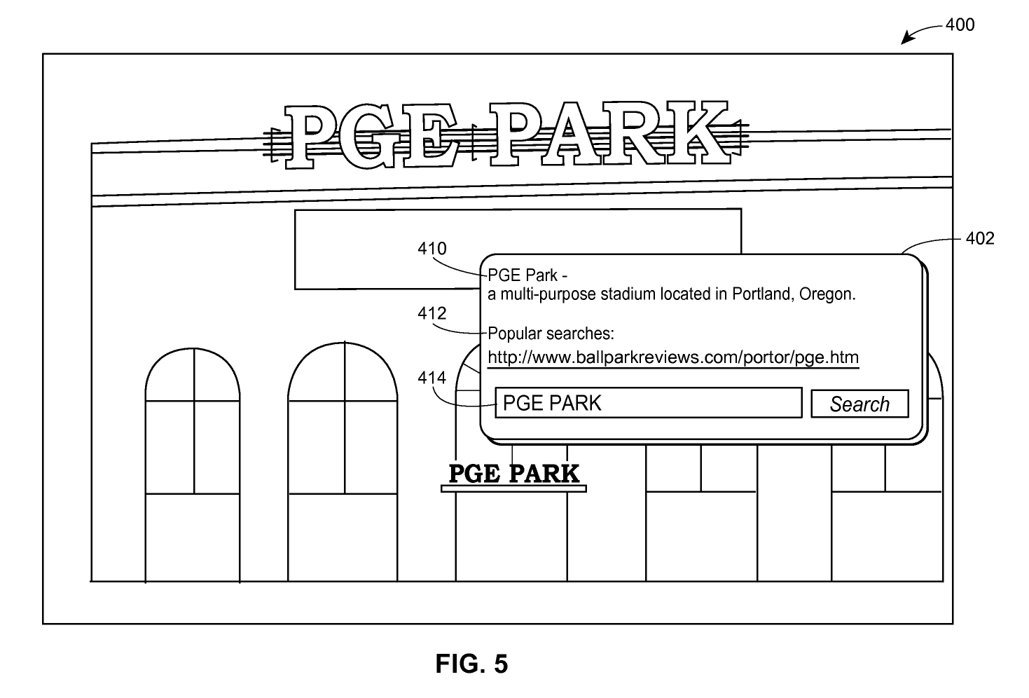

Next, FIGS. 4 and 5 illustrate example screenshots showing overlaid textual information about locations in an interactive 3D scene. Referring back to FIG. 1, the map application 62 may generate the screenshots similar to those illustrated in FIGS. 4 and 5 when providing an interactive 3D display of a geographic area. As illustrated in FIG. 4, in response to the user selecting a location within the displayed imagery 300, the software application displays an expandable overlay window 302.

Depending on the implementation, the software application may determine than a location has been selected when the user clicks or taps on the location with a pointing device (a mouse), stylus, or finger, or when the user “hovers” over the location for a certain amount of time. Moreover, in some cases, the software application may determine than a location has been selected when the simply points to the location or merely moves the pointer over the location. In these cases, the software application may determine that the location is selected without the user explicitly clicking or tapping on the location.

The example overlay window 302 includes the name of the identified symbolic location corresponding to the location on the screen and a control for expanding the overlay window 320. In this implementation, the overlay window 302 is displayed without moving the camera toward the selection location. When the user activates the control for expanding he overlay window 320, the software application may both move the notational camera toward the symbolic location to generate updated imagery 400 and display an expanded overlay window 402 over the selected location (see FIG. 5). In this example, the notational camera is moved so as to directly fact the subject or the symbolic location, but in generally the notational camera can be repositioned in any suitable manner. In addition to the name displayed in the unexpanded overlay window 302, the expanded overlay window 402 includes a brief description of the symbolic location 410, a popular searches list 412 including one or multiple entries, and a search input box with a pre-filled modifiable search term.

As the scene changes, the overlay box 402 may be updated with information relevant to the building, landmark, feature, etc. shown in the map. Similarly, in an overhead view of a street map, as different locations are prominently displayed the overlay box may present relevant information about the location without further user interaction.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, at least some of the operations may be performed by a group of computers (as examples of machines including processors), these operations being accessible via a network (e.g., the Internet) and via one or more appropriate interfaces (e.g., application program interfaces (APIs).)

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for a system and a process for providing information overlaying a scene through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method in a computing device for providing information about geographic locations, the method comprising:
providing, using one or more processors, an interactive three-dimensional (3D) display of geolocated imagery for a geographic area via a user interface of the computing device, including generating a view of the geolocated imagery from a perspective of a notional camera having a particular camera pose, wherein the camera pose is associated with at least position and orientation;
receiving, via the user interface, a selection of a location within the interactive display;
automatically identifying a symbolic location corresponding to the selected location, wherein at least textual information is available for the symbolic location;
automatically and without further input via the user interface, (i) moving the notional camera so as to directly face the selected location, and (ii) providing overlaid textual description of the symbolic location that includes a link to additional information related to the symbolic location.

2. The method of claim 1, wherein providing the overlaid textual description includes displaying a window with a search term input box prefilled with a search term associated with the symbolic location.

3. The method of claim 1, wherein providing the overlaid textual description includes
displaying an expandable informational window with textual description, and
in response to a user activating the expandable informational window, displaying an expanded informational window with a search term input box prefilled with a search term associated with the symbolic location.

4. The method of claim 1, wherein the symbolic location corresponds to a landmark structure or a landmark natural formation.

5. The method of claim 1, wherein providing the overlaid textual description of the symbolic location includes:
identifying, at the computing device, a selected image from among a plurality of images that make up the geolocated imagery, wherein the identified image includes a tag identifying the symbolic location;
sending, via a communication network, the tag to a group of one or more servers, and
receiving, via a communication network, the textual description from the group of servers.

6. The method of claim 5, wherein the tag further identifies a pose of a camera with which the image was captured, wherein the pose includes position and orientation.

7. The method of claim 1, wherein identifying the symbolic location includes sending a portion of the geolocated imagery associated with the selected location to a group of one or more servers.

8. A method in a network device for efficiently providing information about locations displayed via a map application, the method comprising:
receiving, from a client device via a communication network, an indication of a camera position corresponding to a photographic image being displayed on the client device via a map application, wherein the camera position is moved so as to directly face the photographic image;
automatically determining a symbolic location corresponding to the photographic image based on the received indication of the camera position; and
providing, to the client computer, a textual description of the symbolic location and search links related to the symbolic location for use at the client device to display the textual description and search links in an overlay layer of the map application.

9. The method of claim 8, further comprising receiving an indication of a type of map with which the photographic image is being displayed.

10. The method of claim 8, wherein receiving the indication of the camera position includes receiving one or more of:
(i) latitude and longitude of the camera,
(ii) orientation of the camera, and
(iii) camera frustum.

11. The method of claim 8, further comprising receiving a tag identifying the symbolic location depicted in the image from the client device.

12. The method of claim 8, further comprising:
performing, with the server, an Internet search of the symbolic location;
receiving, with the server, one or more results from the Internet search;
selecting, with the server, a representative text description of the symbolic location;
preparing, with the server, one or more links to at least one popular search term associated with the symbolic location; and
storing the representative text description and the one or more links at a computer memory accessible by the server.

13. The method of claim 12, wherein the providing the textual description comprises providing the representative text description and the one or more links stored at the computer memory.

14. A computing device comprising:
one or more processors;
a computer-readable memory coupled to the one or more processors;
a network interface configured to transmit and receive data via a communication network;
a user interface configured to display images and receive user input;
a plurality of instructions stored in the computer-readable memory that, when executed by the one or more processors, causes the computing device to:
provide an interactive display of geolocated imagery for a geographic area via the user interface,
receive, via the user interface, a selection of a location within the interactive display,
automatically identify a symbolic location corresponding to the geolocated imagery at the selected location, and
automatically and without further input via the user interface, update the interactive display to organize the geolocated imagery so as to directly face the subject and provide overlaid textual description of the identified subject including an interactive link to additional information.

15. The computing device of claim 14, wherein the plurality of instructions provide a 3D display of geolocated imagery and implement a set of controls for navigating the 3D display.

16. The computing device of claim 14, wherein the plurality of instructions, when executed by the one or more processors, further cause the computing device to display a window with a search term input box prefilled with a search term associated with the symbolic location.

17. The computing device of claim 14, wherein the plurality of instructions, when executed by the one or more processors, cause the computing device to:
display a compact informational window with textual description, and
in response to a user activating the expandable informational window, display an expanded informational window with a search term input box prefilled with a search term associated with the symbolic location.

18. The computing device of claim 14, wherein the symbolic location corresponds to a landmark structure or a landmark natural formation.

19. The computing device of claim 14, to provide the overlaid textual description of the symbolic location, the plurality of instructions are configured to:
identify, at the computing device, a selected image from among a plurality of images that make up the geolocated imagery, wherein the identified image includes a tag identifying the symbolic location;
send, via the communication network, the tag to a group of one or more servers, and
receive, via a communication network, the textual description from the group of servers.

20. The computing device of claim 18, wherein the tag further identifies a pose of a camera with which the image was captured, wherein the pose includes position and orientation.
